(19) United States
(12) Patent Application Publication
(10) Pub. No.: US 2024/0121854 A1
(43) Pub. Date: Apr. 11, 2024

(54) INDICATION OF CELL STATUS

(71) Applicant: Nokia Technologies Oy, Espoo (FI)

(72) Inventors: Lei DU, Beijing (CN); Lars DALSGAARD, Oulu (FI); Yueji CHEN, Hangzhou (CN)

(21) Appl. No.: 18/572,540

(22) PCT Filed: Jun. 24, 2021
(86) PCT No.: PCT/CN2021/102211

§ 371 Date: Dec. 20, 2023

(51) Int. Cl. H04W 76/20; H04W 36/00; H04W 36/32

(52) U.S. Cl. CPC H04W 76/20; H04W 36/0058; H04W 36/32

(57) ABSTRACT

Example embodiments of the present disclosure relate to indication of cell status. A first device includes at least one processor; and at least one memory including computer program codes; wherein the at least one memory and the computer program codes are configured to, with the at least one processor, cause the first device to: determine a cell status of a deactivated cell, the cell status being a known status or an unknown status; and indicate the cell status to a second device.

### FIELD

Embodiments of the present disclosure generally relate to the field of telecommunication and, in particular, to a method, device, apparatus and computer readable storage medium for indication of cell status.

### BACKGROUND

In a communication system, such as New Radio (NR) and Long Term Evolution (LTE), a Secondary Cell (SCell) can be activated or deactivated to enable reasonable User Equipment (UE) battery consumption when Carrier Aggregation (CA) is configured. The transitions between activated status and deactivated status may be based on Media Access Control (MAC) Control Element (CE) commands from a network device. For example, the SCell activation/deactivation MAC CE commands from the network device may indicate to the UE whether a SCell with SCell index i shall be activated or deactivated.

When a UE receives an activation command to activate a deactivated SCell, it takes activation time, i.e. activation delay, to transit from the deactivated status to the activated status. The activation delay required by the UE may be varied depending on several factors such as whether the SCell is known or unknown, whether the SCell belongs to Frequency Band 1 (FR1) or Frequency Band 2 (FR2), etc.

### SUMMARY

In general, example embodiments of the present disclosure provide a solution for signalling indication of cell status of a deactivated cell so as to keep cell status alignment between the terminal device and the network device to achieve a more proper synchronization.
In a first aspect, there is provided a first device. The first device includes at least one processor; and at least one memory including computer program codes; wherein the at least one memory and the computer program codes are configured to, with the at least one processor, cause the first device to: determine a cell status of a deactivated cell, the cell status being a known status or an unknown status; and indicate the cell status to a second device.
In a second aspect, there is provided a method. The method includes determining a cell status of a deactivated cell, the cell status being a known status or an unknown status; and indicating the cell status to a second device.
In a third aspect, there is provided an apparatus comprising means for determining a cell status of a deactivated cell, the cell status being a known status or an unknown status; and means for indicating the cell status to a second device.
In a fourth aspect, there is provided a non-transitory computer readable medium comprising program instructions for causing an apparatus to perform at least the method according to the above second aspect.

With the solution of the present disclosure, a cell status may be indicated from the UE to the network device or from the network device to the UE, so as to keep status alignment between the UE and the network device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication system in which example embodiments of the present disclosure may be implemented;

FIG. 2 illustrates a flowchart illustrating a process for indicating the cell status according to some example embodiments of the present disclosure;

FIG. 3 shows a flowchart of an example process implemented at the first device in accordance with some example embodiments of the present disclosure;

FIG. 4 shows a flowchart of an example process implemented at the first device in accordance with some example embodiments of the present disclosure;

FIG. 5 shows a flowchart of an example process implemented at the first device in accordance with some example embodiments of the present disclosure;

FIG. 6 is a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry), and
(b) combinations of hardware circuits and software, such as (as applicable):
   (i) a combination of analog and/or digital hardware circuit(s) with software/firmware, and
   (ii) any portions of hardware processor(s) with software (including digital signal processor(s), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” or “communication system” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto node, a pico node, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The activation delay required by UE for activating a deactivated cell may vary depending on several factors such as whether the SCell is known or unknown, whether the SCell belongs to Frequency Band 1 (FR1) or Frequency Band 2 (FR2), etc. The deactivated cell could be SCell or PSCell.

As different activation time is expected for different status (e.g., known or unknown) of the deactivated SCell, the network device would need to understand the status of the deactivated SCell and how the UE behaves at SCell activation so as to start network scheduling at the earliest time. Hence, known status and unknown status are defined to align the understanding of the cell status between the UE and the network device, which will then decide the SCell activation delay.

However, the network device may only presume the status of the SCell depending on whether it has received a valid measurement report from the UE about the SCell within a predetermined time period, if received at all. If the actual status of the SCell is different from the presumed status, the network device may use an inaccurate activation delay assumption for network scheduling. For example, if the SCell is presumed to be “unknown” by the network device while it is actually “known” for the UE, the activation time determined by the network device may be unnecessarily or relatively long and thus resources are wasted. For another example, if the SCell is presumed to be “known” by the network device while it is actually “unknown” for the UE, the activation time determined by the network device may be relatively short and thus synchronization may not be properly achieved and the cell activation procedure may fail.

Therefore, it is required to investigate a solution to improve alignment of the SCell status between the UE and the network device to achieve proper synchronization and SCell activation.

There could be various ways to keep cell status aligned between the UE and the network device to facilitate network scheduling, according to embodiments of the present disclosure. Depending on the different triggers of the cell status determination and reporting, the present disclosure provides several embodiments, details of which will be given below with reference to the accompanying drawings.

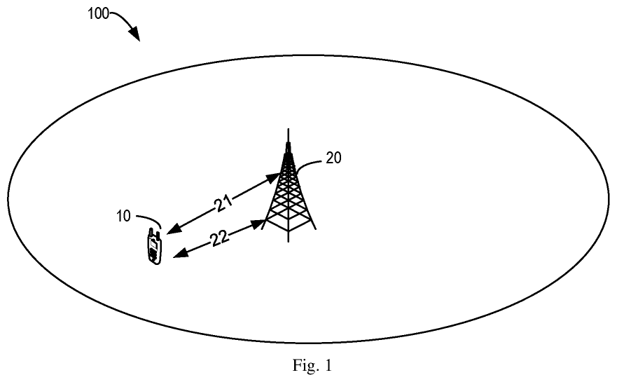

Reference is first made to FIG. 1, which illustrates an example communication system 100 in which example embodiments of the present disclosure may be implemented. The system 100 may include one or more terminal devices, such as a terminal device 10 (hereinafter may also be referred to as a first device or a second device in different embodiments), and one or more network devices, such as a network device 20 (hereinafter may also be referred to as a second device or a first device in different embodiments).

It is to be understood that the number of network devices and terminal devices is only for the purpose of illustration without suggesting any limitations. The communication system 100 may include any suitable number of network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

If CA is configured in the communication system 100, the network device 20 may serve the terminal device 10 on one or more carriers on one or different frequency bands (also called as cells) including a Primary Cell (PCell) 21 and one or more Secondary Cells (SCells) or Primary Secondary Cell (PSCell) 22 (only one SCell 22 is illustrated as an example in FIG. 1). SCell 22 may be in an activated state or a deactivated state if configured, herein also referred to as an activated SCell or a deactivated SCell. The terminal device 10 could not transmit or receive data to or from the network device 20 on a deactivated SCell 22. When the SCell 22 is deactivated, the terminal device 10 may not need to receive the corresponding Physical Downlink Control Channel (PDCCH) or Physical Downlink Shared Channel (PDSCH), cannot transmit in the corresponding uplink, nor is it required to perform L1/L2 measurements such as e.g. Channel State Information (CSI) measurements on the SCell 22. However, the terminal device 10 may still be required to perform Radio Resource Management (RRM) measurements in the deactivated SCell 22 with relaxed performance. Conversely, when the SCell 22 is activated, the terminal device 10 may receive the corresponding PDSCH and PDCCH (if the terminal device 10 is configured to monitor PDCCH from this SCell) and is expected to be able to perform L3 RRM measurements and L1 measurements such as e.g. CSI measurements and report those as configured.

The activation delay requirement T_{activation_time} within which the UE shall be able to activate the deactivated SCell depends on the SCell conditions including whether the SCell is known or unknown, whether the SCell belongs to FR1 or FR2, whether there is already a serving cell on the same FR2 band or not, whether periodic or semi-persistent CSI-RS is used for CSI reporting, etc.

This is due to the different UE behaviors for different SCell conditions upon receiving the SCell activation command. In particular, if the UE has detected or identified the to-be-activated cell upon receiving the SCell activation command, it can immediately start monitoring DL reference signals (e.g., Synchronization Signal Block (SSB)) for fine time and/or frequency synchronization and proceed with the data reception/transmission. Otherwise, the UE needs more time to allow for worst case which may include cell identification procedure including Primary Synchronization (PSS)/Secondary Synchronization Signal (SSS) detection, SSB index acquisition and SSB based measurements, for example, which may lead to longer activation time of the SCell. As different activation time is expected for different SCell conditions, the network device would need to understand the SCell condition (e.g., whether the deactivated SCell is known or unknown) and how the UE behaves at SCell activation so as to start network scheduling at the earliest time.

For explanation, the network device may presume that a deactivated SCell is in a known status if the network device has received a valid measurement result within a certain time period before transmitting the SCell activation command. Therefore, the network device may estimate the UE activation behavior based on such a presumed known status. The known status also depends on the SCell conditions and that the SCell remains detectable during the SCell activation delay according to the cell identification conditions specified.

However, the actual SCell field conditions and situation may be constantly changing in a wireless environment and the actual SCell conditions at SCell activation may only be visible and known by the UE and not by the network device in some scenarios.

For example, in some cases, the cell status determined by the network device based on the known/unknown conditions (which depends on the reporting timing) may not be aligned with the actual cell status detected by the UE (which may be based on more recent measurements and/or other available information at UE).

In one example, the network determines the SCell to be in an unknown status if the received measurement report has expired, e.g., it was received 5 s ago in FR2. However, at the UE the SCell conditions are still suitable enough and the UE is able to identify the SSB and the last reported SSB is still with good quality. In this case, the UE may be able to determine the SCell to be in a known status and activate the SCell very quickly upon reception of the cell activation command.

On the other hand, in some cases, the network device may have the up-to-date information of the cell status which may overweight the known/unknown condition. For example, a SCell is determined to be in an unknown status by the UE as it is the first SCell to be activated on one FR2 band. However, the network device may know that the SCell is collocated with another activated cell or known cell (although not in the same band). In this case, the network device is actually able to reduce the activation delay of the to-be-activated SCell based on this collocated active cell(s). At the UE side, without knowing the collocation information, the UE has to start from cell identification i.e. beam sweeping to activate the SCell.

In these example cases, either the UE has to change its behavior to align with the network device's understanding about the status (i.e., known or unknown) of the cell to be activated, or the network device may misunderstand the UE behavior and derive a false activation delay. Therefore, the closer alignment on the cell status is expected to help the network device better understand the UE activation behavior. This also helps the network device make proper scheduling decision based on the exact timing of cell activation.

Some embodiments propose that the UE and the network device align the cell status, e.g., when the actual status is different from the cell status presumed by current known/unknown conditions. In some embodiments, the UE determines cell status of a deactivated cell and indicate the cell status to the network device at its own initiative or in response to an activation command, a request from the network device or a trigger event. This present disclosure can also be used for directly activating a deactivated cell. Hence, if the status of the to-be-activated cell has changed since it was last reported or the time since last measurement reporting has exceeded a predetermined time limit, the UE may inform the network device about the change of the cell status before, during or after activating the deactivated cell. Embodiments of the disclosure are described in detail below in connection with the accompanying drawings.

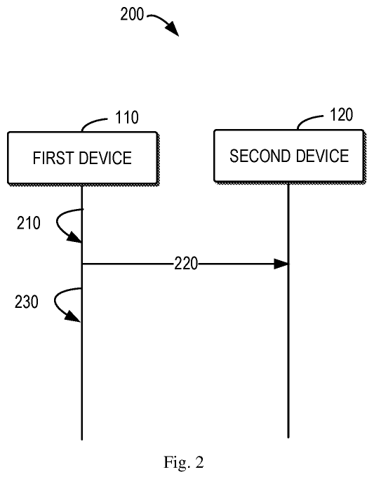

Reference is now made to FIG. 2, which shows a process 200 for indicating the cell status according to some example embodiments of the present disclosure. For the purpose of discussion, the process 200 will be described with reference to FIG. 1. The process 200 may involve a first device 110 and a second device 120. Also general terms of first device and second device are used in the following description, they may refer to different entities in different embodiments. Those skilled in the art may understand that the specific terms are not intended to limit the scope of the present disclosure, and in some applicable cases, the first device and the second device may be used interchangeably. For example, in some embodiments, the first device 110 may include a terminal device 10 and the second device 120 may include a network device 20 as illustrated in FIG. 1, while in some other embodiments, the first device 110 may include a network device 20 and the second device 120 may include a terminal device 10 as illustrated in FIG. 1.

In the process 200, at 210, the first device 110 may determine a cell status of a deactivated cell i.e. the actual status of the deactivated cell. Herein, the cell status refers to a known status or an unknown status. In particular, if the first device 110 may detect or identify the deactivated cell directly, the cell status of the deactivated cell would be regarded as a known status; otherwise, it would be regarded as an unknown status. If the cell status of the deactivated cell is a known status, the required activation time for activating the deactivated cell may be relatively short since the terminal device 10 may immediately start monitoring DL reference signals (i.e. SSB) for fine time and/or frequency synchronization and proceed with the data reception/transmission upon receipt of an activation command from the network device 20 for the deactivated cell. If the cell status of the deactivated cell is an unknown status, the required activation time for activating the deactivated cell may be relatively long since the terminal device 10 may need more time for the cell identification procedure including PSS/SSS detection, SSB index acquisition and SSB based measurement.

At 220, the first device 110 may indicate the cell status to the second device 120. In some embodiments, first device 110 may explicitly indicate a status (i.e., known or unknown) of the cell, while in some embodiments, the first device 110 may indicate the status of the cell implicitly e.g., by indicating whether the status of the cell is changed, or by indicating information for deriving the status of the cell. That is, herein, the first device may indicate the cell status per se or a change of the cell status, based on which the second device 120 may derive or update the cell status of the deactivated cell.

With the process 200, the actual cell status of a deactivated cell may be aligned between the terminal side and the network side such that the network device 20 may perform network scheduling based on the actual cell status of the deactivated cell and the terminal device 10 may activate the deactivated cell based on the actual cell status.

Depending on whether the process 200, especially 210, is triggered by the terminal device 10 or the network device 20, the first device 110 may be the terminal device 10 or the network device 20 in FIG. 1 and the second device 120 may be the other one, which will be described in detail below in connection with different embodiments.

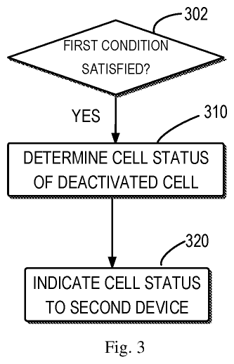

FIG. 3 shows a flowchart of an example process 300 implemented at the first device 110 in accordance with some example embodiments of the present disclosure. Compared with the process 200, the process 300 provides more example embodiments on the determination of the cell status of the deactivated cell at 210. In the example process 300, the first device 110 may comprise the terminal device 10 and the second device 120 may comprise the network device 20.

As shown in FIG. 3, at block 302 of the process 300, the first device 110 may determine whether a first condition for cell status determination of the deactivated cell is satisfied. In some embodiments, the first condition may comprise one of more of the following: an activation command for the deactivated cell is received, a request for reporting or updating the cell status of the deactivated cell is received, a measurement of the deactivated cell is obtained, a timer for cell status determination of the deactivated cell is expired, or a data transmission between the first device and the second device is initiated. That is, in some embodiments, the determination operation of the cell status of the deactivated cell at block 302 may be triggered by an explicit operation command from the network device 20 while in other cases it may be triggered by the first device 110. The first condition may be predefined in the system 100. The first condition may also be preconfigured by the network device 20. In this case, the network device 20 may indicate the first condition to the terminal device 10 through downlink signalling such as downlink Radio Resource Control (RRC) signalling.

If it is determined at block 302 that the first condition for cell status determination of the deactivated cell is satisfied (YES at block 302), at block 310, similar to 210 of FIG. 2, the first device 110 may determine the cell status of the deactivated cell.

The cell status may be determined based on one or more measurements of the deactivated cell available at the first device 110. The terminal device 10 may regularly measure its cells and may report the measurements to the network device 20 e.g. periodically. However, the period for making the measurements may be smaller than that for reporting the measurements. Therefore, the measurements of the deactivated cell obtained and available at the terminal device 10 may be more up to date than that reported to the network device 20, and the measurement(s) available at the terminal device 10 may be used to determine the actual cell status of the deactivated cell. The cell status may be determined based on just one measurement of the deactivated cell such as the latest measurement or may be determined based on combination of a plurality of measurements. For example, the terminal device 10 may obtain different types of measurements such as the SSB or the CSI-RS for one or more beams, any one or combination of which may be used to determine the cell status of the deactivated cell.

In particular, the measurements of the deactivated cell available at the first device 110 may be those obtained by the terminal device 10 regularly or those measured by the terminal device 10 in response to any command such as an operation command received from the network device 20.

As described, in some embodiments, the first condition for cell status determination may include reception of an activation command for activating the deactivated cell. In this regard, the determination of the cell status is implemented at the terminal device 10 triggered by reception of the activation command for the deactivated cell from the network device 20.

Alternatively or additionally, the first condition for cell status determination may comprise reception of a request for reporting the cell status of the deactivated cell from the second device 120. In this regard, the determination of the cell status is implemented at the terminal device 10 triggered by reception of the request for reporting the cell status from the network device 20. The request may be an explicit request that is defined to do so or an implicit request such as a handover (HO) command that may activate the deactivated cell during the handover procedure, e.g. the direct SCell activation. The request may be carried in MAC signalling, physical layer signalling, for example, or other signalling.

Alternatively or additionally, the first condition for cell status determination may include obtainment of a measurement for the deactivated cell at the terminal device 10 or expiration of a timer configured at the terminal device 10 for cell status determination. For example, if the terminal device 10 makes measurements regularly or on demand and the measurement for the deactivated cell is obtained, the determination of the cell status may be triggered. The measurement performed by terminal device 10 may indicate whether the cell state has changed. In another example, a timer for cell status determination may be configured at the terminal device 10. In this case, the determination of the cell status may be triggered by the expiration of the timer. In some embodiments, the determination of the cell status may be periodically triggered at the terminal device 10.

Alternatively or additionally, the first condition for cell status determination may include initiation of a data transmission between the terminal device 10 and the network device 20. For example, when data exchange is initiated by either the terminal device 10 or the network device 20, this may trigger the terminal device 10 to update the cell status to the network device 20. This may bring the cell status update to the network device 20 in an early phase to let the network device 20 know the current status of the cell.

Then at block 320, similar to 220 of FIG. 2, the first device 110 may indicate the cell status of the deactivated cell to the second device 120. The cell status indicated is based on the determination of the cell status in block 310.

On the other hand, if it is determined at block 302 that the first condition for cell status determination is not satisfied, the first device 110 may not determine the cell status of the deactivated cell and may not need to indicate the cell status to the second device 120 (omitted from FIG. 3).

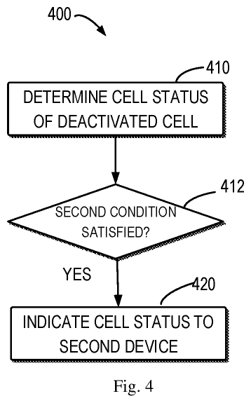

FIG. 4 shows a flowchart of an example process 400 implemented at the first device 110 in accordance with some example embodiments of the present disclosure. Compared with the process 200 or 300, the process 400 provides more embodiments on the indication of the cell status of the deactivated cell at 220 or 320, and it may be implemented independently from or in combination with the process 300. In the example process 400, the first device 110 may comprise the terminal device 10 and the second device 120 may comprise the network device 20.

In the example process 400, the indication of the cell status at the terminal device may be triggered by a second condition such as command or request from the second device 20 or the change of the cell status of the deactivated cell.

As shown in FIG. 4, at block 410 of the process 400, similar to 210 of FIG. 2 and block 310 of FIG. 3, the first device 110 may determine the cell status of the deactivated cell.

At block 412, the first device 110 may determine whether a second condition for cell status indication is satisfied.

In some embodiments, the second condition for cell status indication is similar to the first condition for cell status determination as in the above process 300. In particular, the second condition for cell status indication may include reception of the activation command for the deactivated cell from the second device 120 and/or reception of the explicit request for reporting the cell status of the deactivated cell from the second device 120. If the activation command and/or the request is received from the second device 120, the first device 110 may determine that the second condition for cell status indication is satisfied, and indicate the cell status to the second device 120. Also, the second condition may be predefined or preconfigured by the network device 20, similar to the first condition.

Alternatively or additionally, the second condition for cell status indication may include detecting a change of the cell status of the deactivated cell. In some embodiments, the change of the cell status is detected if the actual cell status of the deactivated cell is different from a presumed or earlier indicated cell status of the deactivated cell. Therefore, if the first device 110 determines that the cell status determined at block 410 is different from the presumed or earlier indicated cell status of the deactivated cell, it may determine that the change of the cell status of the deactivated cell is detected, and thus the second condition for cell status indication is satisfied.

In some embodiments, the presumed cell status may be determined based on one or more measurement reports of the deactivated cell within a time period before receiving the activation command for the deactivated cell from the network device 20.

In some other embodiments, the presumed cell status may be determined without considering the one or more measurements of the deactivated cell available at the terminal device 10.

Alternatively or additionally, the second condition for cell status indication may include expiration of a timer configured at the terminal device 10 for cell status indication. For example, a timer for cell status indication may be configured at the terminal device 10. In this case, the indication of the cell status may be triggered by the expiration of the timer. In some embodiments, the indication of the cell status may be periodically triggered at the terminal device 10.

In some embodiments, the change of the cell status of the deactivated cell may be detected based on at least one of the following options 1) to 4).
1) whether a predetermined time period starting from reporting a measurement report has expired.

As stated above, the terminal device 10 may transmit measurement reports about the deactivated cell with a configured periodicity or based on a request or trigger event. For example, from the terminal side, if a predetermined time period (max(5*measCycleSCell, 5*DRX cycles) for FR1, for example) starting from reporting a measurement report about the deactivated cell has expired, the change of the cell status of the deactivated cell is detected. Otherwise, if the predetermined time period starting from reporting the measurement report about the deactivated cell has not expired, the change of the cell status of the deactivated cell is not detected.
2) whether a latest measurement report is still valid.

As stated above, the terminal device 10 may measure its cells regularly or on demand. In some embodiments, if it is determined that the latest measurement report (such as the SSB index) that was reported to the network device 20 is still valid, the change of the cell status of the deactivated cell is not detected. Otherwise, the change of the cell status of the deactivated cell is detected.
3) whether the deactivated cell is detectable.

In some embodiments, the terminal device 10 may detect the deactivated cell to see whether it is still detectable. If it is determined that the deactivated cell is still detectable, e.g. the channel quality is better than a threshold, the change of the cell status of the deactivated cell is not detected. Otherwise, the change of the cell status of the deactivated cell is detected.
4) whether the deactivated cell is co-located with another activated cell.

In some embodiments, the terminal device 10 may get information on whether the deactivated cell is co-located with another activated or known cell. For example, the terminal device 10 may receive collocation information from the network device 20 that may include co-located cells. If the deactivated cell which is previously presumed to be unknown is co-located with another activated cell, the deactivated cell may be easily identified or presumed identified. In this case, the change of the cell status of the deactivated cell is detected, i.e., the status of deactivated cell is determined to be changed from unknown to known. Otherwise, the change of the cell status of the deactivated cell is not detected.

In one embodiment, the terminal device 10 may detect initiation of a data transmission between the terminal device 10 and the network device 20, and thus the second condition for cell status indication is satisfied.

Moreover, some of the above options may be combined to detect the change of the cell status of the deactivated cell. In one embodiment, option 1) may be combined with option 2) or 3) to determine the change of the cell status of the deactivated cell. For example, if a predetermined time period starting from reporting a measurement report has expired, and the presumed status of the deactivated cell is “unknown”, but the terminal device 10 determines that latest measurement report is still valid (within 5 seconds, for example) or the deactivated cell is detectable, it may determine that the actual cell status is “known”, which is different from the presumed cell status, i.e., the change of the cell status is detected. For another example, the predetermined time period starting from reporting a measurement report has not expired, and the presumed status of the deactivated cell is “known”, but the terminal device 10 determines that latest measurement report is not valid any more or the deactivated cell is not detectable (due to moving of the terminal device 10 or link quality degradation, for example), it may determine that the actual cell status is “unknown”, which is different from the presumed cell status, i.e., the change of the cell status is detected. In another example the terminal device determine that the actual cell status is different from the presumed cell status, where the cell status is then indicated to the second device when data transmission is initiated.

In these cases, the terminal device 10 may indicate the change of the cell status of the deactivated cell to the network device 20.

Continued with FIG. 4, if it is determined at block 412 that the second condition for cell status indication is satisfied (YES at block 412), at block 420, similar to 220 of FIG. 2 and block 320 of FIG. 3, the first device 110 may indicate the cell status of the deactivated cell to the second device 120. The cell status indicated is based on the determination of the cell status in block 410.

On the other hand, if it is determined at block 412 that the second condition for cell status indication is not satisfied, the first device 110 will not indicate the cell status to the second device 120 (omitted from FIG. 4).

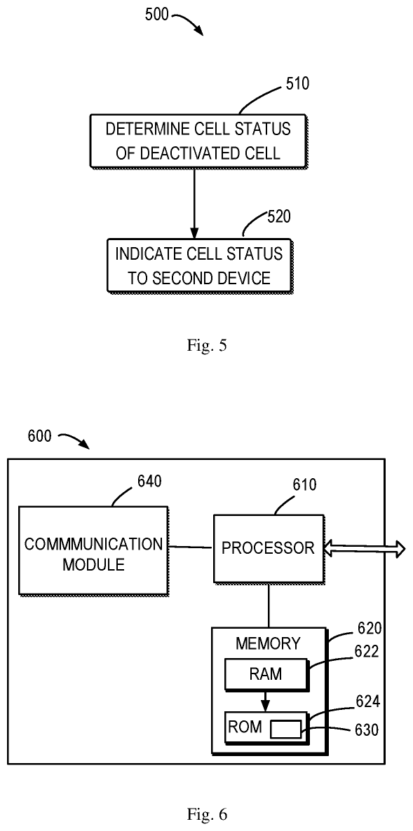

FIG. 5 shows a flowchart of an example process 500 implemented at the first device 110 in accordance with some example embodiments of the present disclosure. In some embodiments, the first device 110 may include a terminal device (e.g., terminal device 10 in FIG. 1) and the second device 120 may include a network device (e.g., the network device 20 in FIG. 1). In this case, at block 510, the terminal device determines a cell status of a deactivated cell, and at bock 520, the terminal device indicates the cell status to the network node. In some example embodiments, the triggering conditions for cell status determination and indication, the factors for determining the cell status, and/or the example implementation for indicating the cell status described above with reference to FIGS. 2-4 also apply here. In some embodiments, the process 500 may be initiated by the network device 20 in case that the to-be-activated cell (i.e., the deactivated cell, such as the SCell 22 in FIG. 1) is co-located with another activated or known cell (such as a SpCell (Secondary primary cell) not shown in FIG. 1), and it may be implemented independently from or in combination with the process 300 and/or 400. In this example, the first device 110 may refer to the network device 20 and the second device 120 may refer to the terminal device 10.

In the process 500, at block 510, the first device 110 may determine a cell status of a deactivated cell. For instance, the network device 20 may determine whether the deactivated cell is co-located with another activated or known cell, or can be considered as collocated with another activated or known cell, as described in the above option 4) of the process 400. For example, if the deactivated cell is the first SCell to be activated on one FR2 band at the terminal device 10, the deactivated cell would be presumed by the terminal device 10 to be in an unknown status. However, if the network device 20 knows that the deactivated cell to be activated is collocated with another activated cell such as a SpCell, the network device 20 may be able to reduce the activation time of the deactivated cell based on its co-located activated cell. In this case, the network device 20 may determine the cell status of the deactivated cell is the known status.

After determining the cell status of the deactivated cell, at block 520, the first device 110 may indicate the cell status to the second device 120 (i.e., the known status or the unknown status). For instance, the network device 20 may transmit collocation information indicating the collocation of the deactivated cell and the activated cell to the terminal device 10. In this case, the network device 20 indicates the cell status to the terminal device 10 implicitly. In some other embodiments, the network device 20 may transmit an explicit indication of the known or unknown status of the deactivated cell. Optionally, the network device 20 may additionally transmit the cell index of the activated cell or known cell, based on which the terminal device 10 is able to activate the deactivated cell.

The terminal device 10, upon receipt of the indication of the cell status, may easily identify the deactivated cell without sweeping.

The process 500 is especially beneficial for direct cell activation where the network device may indicate known/unknown status when initiating the HO command. For direct cell activation, it can be used e.g. with HO where the network device configures the cell with the HO command and activates it directly. Upon receiving the indication, the terminal device will presume the to-be-activated cell is collocated and proceed the activation cell without cell wide sweeping. Optionally, the network device may further indicate the SSB index the UE shall monitor for DL.

In the above embodiments, different scenes are provided for cell status determination and/or cell status reporting/indication. Generally, the cell status determination and/or cell status reporting of the present disclosure may be based on any available information at the terminal device, e.g. any of the SSBs measured at reception of cell activation command, the measurement results which have been or have not been reported to the network device, the mobility status, the cell deployment status etc. Furthermore, the determination of the cell status may be based on any readily available measurements already performed by the terminal device and would not bring any new measurements on the terminal side so as not to increase the activation latency. Alternatively, such a determination may also be requested by the network device and thus a new set of measurements is required.

In some further embodiments, the above process 200, 300, 400 or 500 may further include an additional operation such as the operation 230 shown in FIG. 2, of activating the deactivated cell based on the indicated cell status and an activation command for activating the deactivated cell.

In some embodiments, an activation delay requirement for activating the deactivated cell may be determined based on the indicated cell status and then the activation of the deactivated cell may be completed within the determined activation delay requirement.

As stated above, the activation delay requirement depends on several factors including the known or unknown status of the deactivated cell. In this regard, after the indication of the cell status of the deactivated cell, the terminal device 10 and the network device 20 may get alignment with the updated cell status of the deactivated cell. That is, both the terminal device 10 and the network device 20 may know exactly the actual cell status of the deactivated cell rather than only knowing a presumed cell status.

Therefore, a more exact activation time requirement may be determined based on the actual cell status of the deactivated cell to be activated and thus the actuation may be completed more properly and efficiently. For example, if the presumed cell status is unknown and the actual cell status is known, the network device may presume the terminal device's behavior based on the actual known status and can start scheduling after a decreased activation delay. Additionally, if the terminal device indicates an SSB index update to the network device, the network device may use this information to schedule the terminal device on the indicated SSB.

In some example embodiments, a first apparatus is provided capable of performing any of the processes 200 to 500. The first apparatus may include means for determining a cell status of a deactivated cell, the cell status being a known status or an unknown status; and means for indicating the cell status to a second apparatus. The means may be implemented in any suitable form. For example, the means may be implemented in a circuitry or software module. In some embodiments, the means may comprise one or more processors and one or more memories with computer instructions stored thereon.

In some embodiments, the means for determining the cell status of the deactivated cell includes means for determining the cell status of the deactivated cell if a first condition for cell status determination of the deactivated cell is satisfied. In these embodiments, the first condition for cell status determination of the deactivated cell includes at least one of: reception of an activation command for the deactivated cell from the second device; reception of a request for reporting the cell status of the deactivated cell from the second device; obtainment of a measurement for the deactivated cell at the first apparatus; expiration of a timer configured at the first apparatus for cell status determination; or initiation of a data transmission between the first apparatus and the second apparatus.

In some embodiments, the means for determining the cell status of the deactivated cell includes means for determining the cell status of the deactivated cell based on one or more measurements of the deactivated cell available at the first apparatus.

In some embodiments, the means for indicating the cell status to the second apparatus includes means for indicating the cell status to the second apparatus if a second condition for cell status indication is satisfied. In these embodiments, the second condition for cell status indication includes at least one of: reception of an activation command for the deactivated cell from the second apparatus; reception of a request for reporting the cell status of the deactivated cell from the second device; detection of a change of the cell status of the deactivated cell; expiration of a timer configured at the first apparatus for cell status indication; or initiation of a data transmission between the first apparatus and the second apparatus.

In some embodiments, detection of the change of the cell status of the deactivated cell comprises detection of a difference between the determined cell status of the deactivated cell and a presumed cell status of the deactivated cell. In these embodiments, the presumed cell status is determined based on one or more measurement reports of the deactivated cell within a time period before reception of an activation command for the deactivated cell from the second apparatus, or the presumed cell status is determined without considering one or more measurements of the deactivated cell available at the first device.

In some embodiments, the detection of the change of the cell status of the deactivated cell is based on at least one of: whether a predetermined time period starting from reporting a measurement report has expired; whether a latest measurement report is still valid; whether the deactivated cell is detectable; or whether the deactivated cell is co-located with another activated or known cell.

In some embodiments, the first apparatus further includes means for activating the deactivated cell based on the indicated cell status and an activation command.

In some embodiments, the means for activating the deactivated cell includes means for determining an activation delay requirement for activating the deactivated cell based on the indicated cell status, and means for completing activation of the deactivated cell within the activation delay requirement.

FIG. 6 is a simplified block diagram of a device 600 that is suitable for implementing example embodiments of the present disclosure. The device 600 may be provided to implement the communication device, for example the terminal device 10 or the network device 20 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital versatile disc (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the memory, e.g., ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIGS. 2 to 5. The example embodiments of the present disclosure may also be implemented by hardware or by a combination of software and hardware.

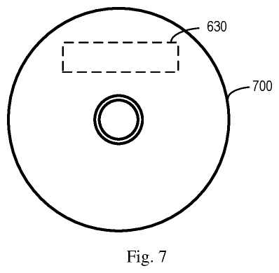

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium 700 has the program 630 stored thereon.

In the description, the embodiments of the present disclosure are described by taking either the terminal device as the first device and the network device as the second device or the network device as the first device and the terminal device as the second device. However, those skilled in the art may understand that the present disclosure is not limited thereto, where applicable, the operations of the terminal device may also be implemented at the network device, and vice versa.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the processes 200, 300, 400 or 500 as described above with reference to FIGS. 2, 3, 4 and 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-22. (canceled)

23. A first device, comprising:
at least one processor; and
at least one memory including computer program codes;
wherein the at least one memory and the computer program codes are configured to, with the at least one processor, cause the first device to:
receive an activation command for a deactivated cell from a second device;
in response to receiving the activation command, determine an actual cell status of the deactivated cell;
detect that the actual cell status of the deactivated cell is different from a presumed or earlier indicated cell status of the deactivated cell;
based on the detecting, indicate the actual cell status to the second device.

24. The first device of claim 23, wherein the first device is further caused to determine the actual cell status of the deactivated cell if a first condition for cell status determination of the deactivated cell is satisfied, wherein the first condition for cell status determination of the deactivated cell includes at least one of:
reception of a request for reporting the cell status of the deactivated cell from the second device;
obtainment of a measurement for the deactivated cell at the first device;
expiration of a timer configured at the first device for cell status determination; or
initiation of a data transmission between the first device and the second device.

25. The first device of claim 23, wherein the first device is caused to determine the actual cell status of the deactivated cell based on one or more measurements of the deactivated cell available at the first device.

26. The first device of claim 23, wherein the first device is further caused to indicate the actual cell status to the second device if a second condition for cell status indication is satisfied, wherein the second condition for cell status indication includes at least one of:
reception of the activation command for the deactivated cell from the second device;
reception of a request for reporting the cell status of the deactivated cell from the second device;
expiration of a timer configured at the first device for cell status indication; or
initiation of a data transmission between the first device and the second device.

27. The first device of claim 23, wherein:
the presumed cell status is determined based on one or more measurement reports of the deactivated cell within a time period before reception of the activation command for the deactivated cell from the second device, or
the presumed cell status is determined without considering one or more measurements of the deactivated cell available at the first device.

28. The first device of claim 23, wherein detection that the actual cell status of the deactivated cell is different from the presumed or earlier indicated cell status of the deactivated cell is based on at least one of:
whether a predetermined time period starting from reporting a measurement report has expired;
whether a latest measurement report is still valid;
whether the deactivated cell is detectable; or
whether the deactivated cell is co-located with another activated or known cell.

29. The first device of claim 23, wherein the at least one memory and the computer program code are configured to, with the at least one processor, further cause the first device to:
activate the deactivated cell based on the indicated actual cell status and the activation command.

30. The first device of claim 29, wherein the first device is caused to activate the deactivated cell by:
determining an activation delay requirement for activating the deactivated cell based on the indicated actual cell status, and
completing activation of the deactivated cell within the activation delay requirement.

31. The first device of claim 23, wherein the actual cell status is known and the presumed or earlier indicated cell status is unknown.

32. The first device of claim 23, wherein the first device is caused to:
detect that the actual cell status of the deactivated cell is not different from a presumed or earlier indicated cell status of the deactivated cell; and
based on the detecting, refrain from indicating the actual cell status to the second device.

33. A method for a first device, comprising:
receiving an activation command for a deactivated cell from a second device;
in response to receiving the activation command, determining an actual cell status of the deactivated cell;
detecting that the actual cell status of the deactivated cell is different from a presumed or earlier indicated cell status of the deactivated cell;
based on the detecting, indicating the actual cell status to the second device.

34. The method of claim 33, wherein determining the actual cell status of the deactivated cell comprises determining the actual cell status of the deactivated cell based on one or more measurements of the deactivated cell available at the first device.

35. The method of claim 33, wherein indicating the actual cell status to the second device comprises indicating the actual cell status to the second device if a second condition for cell status indication is satisfied, wherein the second condition for cell status indication includes at least one of:
reception of an activation command for the deactivated cell from the second device;
reception of a request for reporting the cell status of the deactivated cell from the second device;
expiration of a timer configured at the first device for cell status indication; or
initiation of a data transmission between the first device and the second device.

36. The method of claim 33, wherein
the presumed cell status is determined based on one or more measurement reports of the deactivated cell within a time period before reception of the activation command for the deactivated cell from the second device, or
the presumed cell status is determined without considering one or more measurements of the deactivated cell available at the first device.

37. The method of claim 33, wherein detection that the actual cell status of the deactivated cell is different from the presumed or earlier indicated cell status of the deactivated cell is based on at least one of:
whether a predetermined time period starting from reporting a measurement report has expired;
whether a latest measurement report is still valid;
whether the deactivated cell is detectable; or
whether the deactivated cell is co-located with another activated or known cell.

38. The method of claim 33, further comprising:
activating the deactivated cell based on the indicated actual cell status and the activation command.

39. The method of claim 38, wherein activating the deactivated cell comprises:
determining an activation delay requirement for activating the deactivated cell based on the indicated actual cell status, and
completing activation of the deactivated cell within the activation delay requirement.

40. The method of claim 33, wherein the actual cell status is known and the presumed or earlier indicated cell status is unknown.

41. The method of claim 33, further comprising:
detecting that the actual cell status of the deactivated cell is not different from a presumed or earlier indicated cell status of the deactivated cell; and
based on the detecting, refraining from indicating the actual cell status to the second device.

42. A non-transitory computer readable medium comprising program instructions for causing a first device to perform a method comprising:
receiving an activation command for a deactivated cell from a second device;
in response to receiving the activation command, determining an actual cell status of the deactivated cell;
detecting that the actual cell status of the deactivated cell is different from a presumed or earlier indicated cell status of the deactivated cell;
based on the detecting, indicating the actual cell status to the second device.
